(19) United States
(12) Patent Application Publication
(10) Pub. No.: US 2006/0128853 A1
(43) Pub. Date: Jun. 15, 2006

(54) Compositions for articles comprising replicated microstructures

(75) Inventor: Daniel Robert Olson, Voorheesville, NY (US)

Correspondence Address: Andrew J. Caruso;General Electric Global Research, Docket Room K1-4A59, One Research Circle, Niskayuna, NY, 12309, US

(73) Assignee: General Electric Company, Schenectady, NY (US)

(21) Appl. No.: 11/257,576

(22) Filed: Oct. 25, 2005

Related U.S. Application Data
(63) Continuation-in-part of application No. 11/010,667, filed on Dec. 13, 2004.

(51) Int. Cl. B60C 1/00; C08G 73/10; C08K 3/22

(52) U.S. Cl. 524/261; 524/409; 524/430

(57) ABSTRACT

The present invention provides novel curable compositions useful in the preparation of light management films and other optical articles. The curable compositions comprise (a) at least one silicone-containing surfactant, (b) at least one a multifunctional (meth)acrylate having structure I; (c) at least one nanoparticulate filler; and in certain embodiments, (d) at least one monofunctional (meth)acrylate. The curable compositions may be cured to provide the corresponding cured compositions and articles made therefrom.

### RELATED APPLICATION

This application is a continuation-in-part of U.S. patent application Ser. No. 11/010,667 filed Dec. 13, 2004.

### BACKGROUND

The invention relates generally to curable (meth)acrylate compositions and, more specifically ultraviolet (UV) radiation curable (meth)acrylate compositions. The compositions are suitable for optical articles and particularly for light management films.

In backlight computer displays or other display systems, optical films are commonly used to direct light. For example, in backlight displays, light management films use prismatic structures (often referred to as microstructure) to direct light along a viewing axis (i.e., an axis substantially normal to the display). Directing the light enhances the brightness of the display viewed by a user and allows the system to consume less power in creating a desired level of on-axis illumination. Films for turning or directing light can also be used in a wide range of other optical designs, such as for projection displays, traffic signals, and illuminated signs. Ultraviolet radiation curable (meth)acrylate compositions find use in applications such as display systems. Films for light management applications are typically prepared by curing a composition in common molds, such as nickel or nickel/cobalt electroforms, into the requisite shape.

In the preparation of light management films, the curable compositions employed tend to stick to the molds used for microreplication. This results in poor replication, roughened surfaces, buckling of the coating, and/or catastrophic loss of adhesion to the carrier film and destruction of the mold. In addition, the product light management films lack, in some instances, sufficient abrasion resistance to meet the requirements of a particular application. There remains a continuing need for further improvement in the materials used to make them, particularly materials that upon curing possess the combined attributes desired to satisfy the increasingly exacting requirements for light management film applications.

### BRIEF DESCRIPTION

In one aspect, the present invention provides a curable composition comprising:

(a) at least one silicone containing surfactant, wherein the surfactant is present in a range corresponding to from about 0.01 to about 5 weight percent based upon the total weight of the composition;

(b) a least one multifunctional (meth)acrylate represented by the structure I 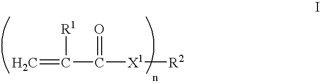
wherein R¹ is hydrogen or methyl; X¹ is O, S, or Se; n is at least 2; and R² is a polyvalent aromatic radical; and

(c) at least one nanoparticulate filler.

In one embodiment, the present invention provides a curable composition comprising:

(a) at least one silicone containing surfactant, wherein the surfactant is present in a range corresponding to from about 0.01 to about 5 weight percent based upon the total weight of the composition;

(b) a multifunctional (meth)acrylate represented by the structure I 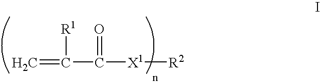
wherein R¹ is hydrogen or methyl; X¹ is O, S, or Se; n is at least 2; and R² is a polyvalent aromatic radical;

(c) at least one nanoparticulate filler; and

(d) at least one monofunctional (meth)acrylate.

In an alternate embodiment, the present invention provides a curable composition comprising

(a) at least one silicone containing surfactant, wherein the surfactant is present in a range corresponding to from about 0.01 to about 5 weight percent based upon the total weight of the composition;

(b) a multifunctional (meth)acrylate represented by the structure I;

(c) at least one nanoparticulate filler; and

(d) at least one monofunctional (meth)acrylate having structure 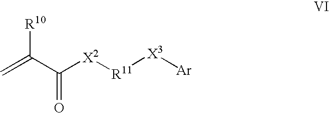
wherein R¹⁰ is hydrogen or methyl; X² and X³ are independently in each instance O, S, or Se; R¹¹ is a divalent C₁-C₂₀ aliphatic radical, a divalent C₃-C₂₀ cycloaliphatic radical, or a divalent C₃-C₂₀ aromatic radical; and Ar is monovalent C₃-C₂₀ aromatic radical.

In yet another embodiment another embodiment, the present invention provides a curable composition comprising:

(a) at least one silicone containing surfactant, wherein the surfactant is present in a range corresponding to from about 0.01 to about 5 weight percent based upon the total weight of the composition;

(b) a multifunctional (meth)acrylate represented by the structure IV 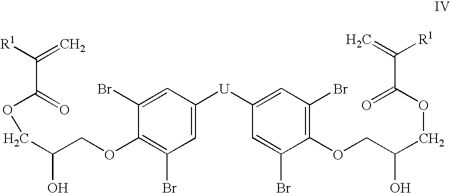
wherein R¹ is hydrogen or methyl, and U is a bond, an oxygen atom, a sulfur atom, a selenium atom, an SO₂ group, an SO group, a CO group, a C₁-C₂₀ aliphatic radical, C₃-C₂₀ cycloaliphatic radical, or a C₃-C₂₀ aromatic radical;

(c) at least one nanoparticulate filler; and (d) at least one monofunctional (meth)acrylate having structure VI.

In yet another embodiment, the present invention provides a cured composition comprising:

(a) at least one silicone containing surfactant, wherein the surfactant is present in a range corresponding to from about 0.01 to about 5 weight percent based upon the total weight of the composition;

(b) structural units derived from at least one multifunctional (meth)acrylate represented by the structure I; and

(c) at least one nanoparticulate filler.

In yet another embodiment, the present invention provides a cured composition comprising:

(a) at least one silicone containing surfactant, wherein the surfactant is present in a range corresponding to from about 0.01 to about 5 weight percent based upon the total weight of the composition;

(b) structural units derived from at least one multifunctional (meth)acrylate represented by the structure I;

(c) at least one nanoparticulate filler; and

(d) structural units derived from at least one monofunctional (meth)acrylate.

In various aspects and embodiments, the present invention provides an article comprising the cured compositions comprising of the invention. In certain embodiments, the articles provided by the present invention are useful as light management films.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The present invention may be understood more readily by reference to the following detailed description of preferred embodiments of the invention and the examples included therein. In the following specification and the claims which follow, reference will be made to a number of terms which shall be defined to have the following meanings.

The singular forms “a”, “an” and “the” include plural referents unless the context clearly dictates otherwise.

As used herein, the term “integer” is defined to be any whole number including zero.

“Optional” or “optionally” means that the subsequently described event or circumstance may or may not occur, and that the description includes instances where the event occurs and instances where it does not.

As used herein, the term “nanoparticulate filler” includes functionalized nanoparticulate fillers and unfunctionalized nanoparticulate fillers.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehydes groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphenl-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₇—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis (cyclohex-4-yl) (i.e., —C₆H₁₀C(CF₃)₂ C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂C₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —O C₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein the term “aliphatic radical” refers to an organic radical having a valence of at least one consisting of a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl (i.e., (CH₃)₃Si—), t-butyldimethylsilyl, 3-trimethyoxysilypropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH₂)₉—) is an example of a C₁₀ aliphatic radical.

The phrase “(meth)acrylate monomer” refers to any of the monomers comprising at least one acrylate unit, wherein the substitution of the double bonded carbon adjacent to the carbonyl group is either a hydrogen or a methyl substitution. Examples of “(meth)acylate monomers” include methyl methacrylate (CAS No. 80-62-6) where the substitution on the double bonded carbon adjacent to the carbonyl group is a methyl group, acrylic acid where the substitution on the double bonded carbon adjacent to the carbonyl group is a hydrogen group, phenyl methacrylate where the substitution on the double bonded carbon adjacent to the carbonyl group is a methyl group, phenyl thioethyl methacrylate where the substitution on the double bonded carbon adjacent to the carbonyl group is a methyl group, ethyl acrylate where the substitution on the double bonded carbon adjacent to the carbonyl group is a hydrogen group, 2,2-bis((4-(meth)acryloxy)phenyl)propane (CAS No. 3253-39-2, also known as Bisphenol A dimethacrylate) where the substitution on the double bonded carbon adjacent to the carbonyl group is a methyl group, Bisphenol A diglyciyl ether dimethacrylate (CAS No. 1565-94-2) where the substitution on the double bonded carbon adjacent to the carbonyl group is a methyl group, and the like.

This invention is related to a curable composition comprising at least one silicone containing surfactant, at least one (meth)acrylate monomer, and at least one nanoparticulate filler.

In one aspect, the curable composition is a solvent-free, high refractive index, radiation curable composition that provides a cured material having an excellent balance of properties. The compositions are ideally suited for light management film applications. In one aspect, light management films prepared from the curable compositions exhibit excellent abrasion resistance.

As noted, in one embodiment, the present invention provides a curable composition comprising (a) at least one silicone containing surfactant, wherein the surfactant is present in a range corresponding to from about 0.01 to about 5 weight percent based upon the total weight of the composition; and (b) a multifunctional (meth)acrylate represented by the structure I 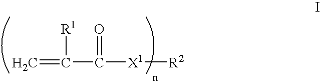
wherein R¹ is hydrogen or methyl; X¹ is O, S, or Se; n is at least 2; and R² is a polyvalent aromatic radical, and (c) at least one nanoparticulate filler.

Thus, in one aspect, the curable composition provided by the present invention does not require the presence of a monofunctional (meth)acrylate in order to provide a useful curable composition, for example a composition which can be used in the preparation of a light management film. In embodiments in which a monofunctional (meth)acrylate is not required, the curable composition may comprise one or more multifunctional (meth)acrylates. In one embodiment, the curable composition comprises at least one multifunctional (meth)acrylate selected from the group consisting of aliphatic diol (meth)acrylates, cycloaliphatic diol (meth)acrylates, and aromatic diol (meth)acrylates. Aliphatic diol (meth)acrylates are multifunctional (meth)acrylates which may be prepared, for example, by reaction of an aliphatic diol such as 1,6-hexanediol with (meth)acryloyl chloride. Cycloaliphatic diol (meth)acrylates are defined analogously and may be prepared in via methods known to those skilled in the art from the corresponding aliphatic diol and (meth)acryloyl chloride. Aromatic diol (meth)acrylates are likewise known to those skilled in the art to be available by reaction of the corresponding aromatic diol with (meth)acryloyl chloride and by other methods. Various mixtures of multifunctional (meth)acrylates may employed to provide useful curable compositions that may be used in the preparation of cured articles such as light management films. In the disclosure which follows, a wide variety of multifunctional (meth)acrylates are described as suitable for use in the curable compositions of the present invention. Such multifunctional (meth)acrylates are also useful in the preparation of curable compositions which do not comprise a monofunctional (meth)acrylate. Although much of the disclosure which follows is directed to curable compositions comprising at least one monofunctional (meth)acrylate, as will be recognized by those skilled in the art, various aspects of the disclosed structures, compositions, and principles apply equally in a number of embodiments to curable compositions not requiring the presence of a monofunctional (meth)acrylate. Thus, for example, in one embodiment the present invention provides a curable composition comprising (a) at least one silicone containing surfactant, wherein the surfactant is present in a range corresponding to from about 0.01 to about 5 weight percent based upon the total weight of the composition; (b) at least one multifunctional (meth)acrylate represented by the structure I wherein R² is a polyvalent aromatic radical having structure III; and (c) at least one nanoparticulate filler. In yet another embodiment, the present invention provides a curable composition comprising (a) at least one silicone containing surfactant, wherein the surfactant is present in a range corresponding to from about 0.01 to about 5 weight percent based upon the total weight of the composition; (b) at least one multifunctional (meth)acrylate represented by the structure IV; and (c) at least one nanoparticulate filler. In yet another embodiment, the present invention provides a curable composition comprising (a) at least one silicone containing surfactant, wherein the surfactant is present in a range corresponding to from about 0.01 to about 5 weight percent based upon the total weight of the composition; (b) at least one multifunctional (meth)acrylate prepared by the ring opening reaction of tetrabromobisphenol A diglycidyl ether with (meth)acrylic acid; and (c) at least one nanoparticulate filler. In still yet another embodiment, the present invention provides a cured composition comprising: (a) at least one silicone containing surfactant, wherein the surfactant is present in a range corresponding to from about 0.01 to about 5 weight percent based upon the total weight of the composition; (b) structural units derived from at least one multifunctional (meth)acrylate having structure I; and (c) at least one nanoparticulate filler. In still yet another embodiment, the present invention provides a cured composition comprising (a) at least one silicone containing surfactant, wherein the surfactant is present in a range corresponding to from about 0.01 to about 5 weight percent based upon the total weight of the composition; and (b) structural units derived from at least one multifunctional (meth)acrylate represented by the structure I wherein R² is a polyvalent aromatic radical having structure III, and (c) at least one nanoparticulate filler. In yet another embodiment, the present invention provides a cured composition comprising (a) at least one silicone containing surfactant, wherein the surfactant is present in a range corresponding to from about 0.01 to about 5 weight percent based upon the total weight of the composition; and (b) structural units derived from at least one multifunctional (meth)acrylate represented by the structure IV; and (c) at least one nanoparticulate filler. In yet another embodiment, the present invention provides a cured composition comprising (a) at least one silicone containing surfactant, wherein the surfactant is present in a range corresponding to from about 0.01 to about 5 weight percent based upon the total weight of the composition; and (b) structural units derived from at least one multifunctional (meth)acrylate prepared by the ring opening reaction of tetrabromobisphenol A diglycidyl ether with (meth)acrylic acid; and (c) at least one nanoparticulate filler.

Typically, the curable compositions of the present invention are liquids at room temperature. In one embodiment, the curable composition of the present invention is a low melting solid (i.e. the composition has a melting point of less than about 50° C.). In yet another embodiment, the curable composition of the present invention has a melting point of less than about 100° C. In an alternate embodiment, the curable composition of the present invention is an amorphous solid having a softening point of less than about 50° C.

The compositions of the present invention are “curable” in the sense that the composition comprises as monomeric species, at least one multifunctional (meth)acrylate and optionally at least one monofunctional (meth)acrylate, which when subjected to curing conditions afford a cured, polymeric composition. Various curing conditions may be employed to convert the curable compositions of the present invention into the corresponding cured compositions. In one embodiment, the composition is “curable” in the sense that it may converted into a cured, polymeric composition upon exposure to ultraviolet (UV) radiation. The curable compositions of the present invention in certain embodiments comprise a photo-active polymerization initiator. Alternatively, the curable compositions of the present invention may comprise a polymerization initiator which may be activated thermally, for example 2,2′-bisazobisiosbutyronitrile (AIBN, CAS No. 78-67-1), 1,1′-azobis(cyclohexanecarbonitrile), 4,4′azobis(4-cyanovaleric acid), 2,2′azobis(2-methylproionamidine) dihydrochloride (CAS No. 2997-924), azo-tert-butane, and the like. In one embodiment, the presence of a polymerization initiator is not required and the curable composition may be polymerized by simply heating or irradiating.

In one embodiment, the curable composition of the present invention comprises a peroxide polymerization initiator. Such peroxy-based initiators that may be used to promote polymerization of the curable composition by thermal activation. Suitable peroxide polymerization initiators include, for example, dibenzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha, alpha′-bis(t-butylperoxy-m-isopropyl)benzene, 2,5-dimethyl-2,5-di(t-butylperoxy)hexane, dicumylperoxide, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and combinations comprising at least one of the foregoing polymerization initiators.

In one embodiment, the curable composition of the present invention comprises a photoinitiator which serves to promote the on-demand polymerization (curing) of the (meth)acrylate components of the curable composition. Suitable polymerization initiators include photoinitiators that promote polymerization of the components upon exposure to ultraviolet radiation. Particularly suitable photoinitiators include phosphine oxide photoinitiators. Examples of such photoinitiators include the IRGACURE® and DAROCUR™ series of phosphine oxide photoinitiators available from CIBA SPECIALTY CHEMICALS; the LUCIRIN® series of photoinitiators available from BASF Corp.; and the ESACURE® series of photoinitiators. Other useful photoinitiators include ketone-based photoinitiators, such as hydroxy- and alkoxyalkyl phenyl ketones, and thioalkylphenyl morpholinoalkyl ketones. Also suitable are benzoin ether photoinitiators.

In one embodiment, the curable composition of the present invention may comprise at least one C₁₀-C₄₀ aliphatic acid. In certain instances, the C₁₀-C₄₀ aliphatic acid component of the curable composition may prevent fouling of surfaces in contact with the composition during polymerization (curing). Thus, for instance, during the preparation of a light management film, such as a brightness enhancement film, comprising surface microstructures the curable composition is contacted with an electroform (also referred to as a “master”, a “shim” or a “cast roll”) comprising surface features which will be replicated in the brightness enhancement film. In order to replicate the microstructures of the electroform in the film, the curable composition is polymerized (cured) while in contact with the electroform. After polymerization of the curable composition, the cured composition comprising the microstructures replicated from the microstructures on the surface of the electroform is disengaged from (peeled from) the electroform. Typically, the cured composition is in the form of a film. As successive microstructure-containing film samples are prepared and peeled from the electroform, fouling of the electroform may occur. In certain embodiments, the presence of at least one aliphatic acid in the curable composition prevents fouling of the electroform, and as a result, the electroform may be used to prepare a greater number of film samples than could be prepared using a curable composition lacking an aliphatic acid component.

In one embodiment, the C₁₀-C₄₀ aliphatic acid component is present in an amount corresponding to from about 0.01 weight percent to about 1 weight percent based upon a total weight of the composition. In an alternate embodiment, the C₁₀-C₄₀ aliphatic acid component is present in an amount corresponding to from about 0.05 weight percent to about 0.5 weight percent based upon a total weight of the composition. In yet another embodiment, the C₁₀-C₄₀ aliphatic acid component is present in an amount corresponding to from about 0.1 weight percent to about 0.4 weight percent based upon a total weight of the composition.

In one embodiment, the C₁₀-C₄₀ aliphatic acid component comprises a carboxylic acid having structure II 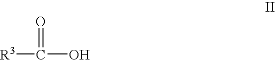
wherein R³ is a C₉-C₃₉ aliphatic radical. Suitable aliphatic acid components include, but are not limited to, naturally occurring and synthetic fatty acids such as palmitic acid, stearic acid, and myristic acid. In one embodiment, the aliphatic acid component comprises at least one fatty acid selected from the group consisting of myristic acid, palmitic acid, stearic acid, oleic acid, linoleic acid, linolenic acid, and eicosanoic acid. In an alternate embodiment, the aliphatic acid component comprises a synthetic C₁₀-C₄₀ aliphatic acid which is not a fatty acid, for example alpha-hexadecyloxy acetic acid, alpha-hexadecylthio acetic acid, alpha-octadecyloxy acetic acid, and the like.

As noted, the curable composition of the present invention comprises at least one a multifunctional (meth)acrylate represented by the structure I. 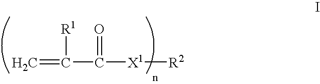
wherein R¹ is hydrogen or methyl; X¹ is O, S, or Se; n is at least 2; and R² is a polyvalent aromatic radical. The term “multifunctional (meth)acrylate” means a composition comprising at least two (meth)acryloyl groups, a (meth)acryloyl group having the structure 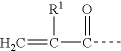
wherein R¹ is hydrogen or methyl and the dashed line (----) signals the point of attachment of the (meth)acryloyl group to the multifunctional (meth)acrylate.

As noted, the group R² is a polyvalent aromatic radical. By “polyvalent aromatic radical” it is meant that R² possesses at least two points of attachment (valences) to which (meth)acryloyl groups may be attached. In one embodiment, R² is a divalent aromatic radical to which may be attached two (meth)acryloyl groups. In an alternate embodiment, R² is a trivalent aromatic radical to which may be attached three (meth)acryloyl groups. R² is an aromatic radical within the definition of the term “aromatic radical” given herein. As such, the group R² comprises at least one aromatic ring. By way of further example, in bisphenol A dimethacrylate, two acryloyl groups are attached to an aromatic radical having the formula C₁₅H₁₄O₂.

In one embodiment, R² is a divalent aromatic radical having structure III 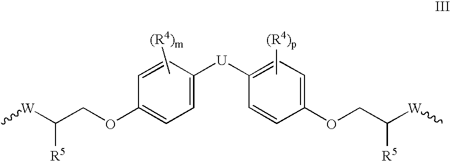
wherein and U is a bond, an oxygen atom, a sulfur atom, a selenium atom, an SO₂ group, an SO group, a CO group, a C₁-C₂₀ aliphatic radical, C₃-C₂₀ cycloaliphatic radical, or a C₃-C₂₀ aromatic radical; R⁴ is independently at each occurrence a halogen atom, a nitro group, a cyano group, an amino group, a hydroxy group, a C₁-C₂₀ aliphatic radical, a C₃-C₂₀ cycloaliphatic radical, or a C₃-C₂₀ aromatic radical; R⁵ is independently at each occurrence a hydrogen atom, a hydroxy group, a thiol group, or an amino group; W is a bond, a divalent C₁-C₂₀ aliphatic radical, a divalent C₃-C₂₀ cycloaliphatic radical, a divalent C₃-C₂₀ aromatic radical; and “m” and “p” are independently integers ranging from 0 to 4.

Suitable aromatic radicals represented by structure III are illustrated by Examples I-1, I-2, I-3,1-4, and I-5, in Table 1, in which the group R² falls within the genus encompassed by structure III. For instance, in Example I-1 of Table 1, R² represents structure III wherein the group U is an isopropylidene group ((CH₃)₂C), the groups R⁴ represent bromine atoms, the values of “m” and “p” are each 2, the 4 bromine atoms are located at the 2, 2′, 6, and 6′ positions of a bisphenol A residue, R⁵ is hydroxy (OH), and “W” represents a methylene (CH₂) group. To further illustrate the relationship between structures I and III, attention is called to Example I-1 of Table 1 wherein each of the terminal methylene groups (----CH₂ or CH₂----) shown in the structure under the heading “R²” (the structure which illustrates generic formula III) serves as the point of attachment for the (meth)acryloyloxy groups

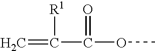

present in the di(meth)acrylate composition represented by structure I wherein R¹ is methyl (Me), X¹ is oxygen (O), and “n”=2.

TABLE 1
MULTIFUNCTIONAL (METH)ACRYLATES HAVING STRUCTURE I

| Example | R¹ | X¹ | n | R² |
|---|---|---|---|---|
| I-1 | Me | O | 2 | 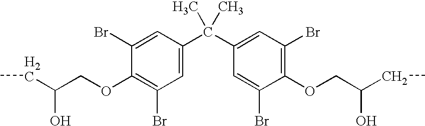 |
| I-2 | H | O | 2 | 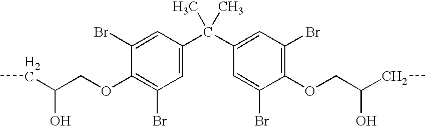 |
| I-3 | H | O | 2 | 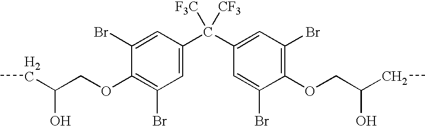 |
| I-4 | H | O | 2 | 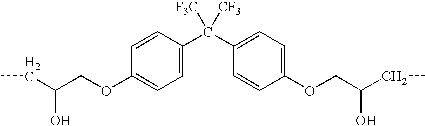 |
| I-5 | M | O | 2 | 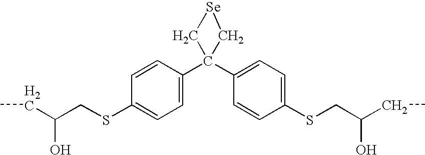 |
| I-6 | Me | O | 2 | 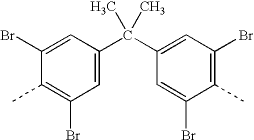 |
| I-7 | Me | S | 2 | 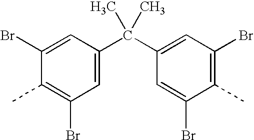 |
| I-8 | Me | O | 3 | 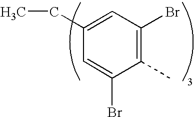 |
| I-9 | Me | S | 2 | 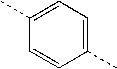 |
| I-10 | Me | S | 2 | 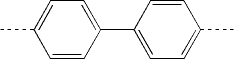 |

In one embodiment, the multifunctional (meth)acrylate comprises at least one di(meth)acrylate having structure IV 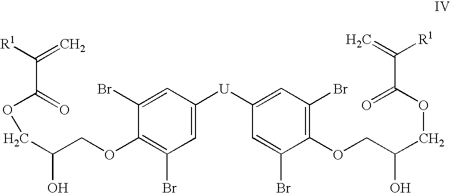
wherein R¹ is hydrogen or methyl, and U is a bond, an oxygen atom, a sulfur atom, a selenium atom, an SO₂ group, an SO group, a CO group, a divalent C₁-C₂₀ aliphatic radical, a divalent C₃-C₂₀ cycloaliphatic radical, or a divalent C₃-C₂₀ aromatic radical.

Brominated di(meth)acrylates falling within the genus represented by structure IV are illustrated by Examples I-1, I-2, and I-3 of Table 1.

As will be appreciated by those skilled in the art, multifunctional (meth)acrylates may be prepared by nucleophilic ring opening of a polyglycidyl ether such as tetrabromobisphenol A diglycidyl ether with acrylic acid or (meth)acrylic acid, and by other methods known to those skilled in the art such as esterification of the hydroxyl groups of a dihydroxy compound comprising the aromatic radical R² with (meth)acryloyl chloride. Suitable polyglycidyl ethers which can serve as precursors to the corresponding multifunctional (meth)acrylate represented by the structure I include bisphenol A diglycidyl ether, bisphenol-F diglycidyl ether, tetrabromo bisphenol-F diglycidyl ether, resorcinol diglycidyl ether, hydroquinone diglycidyl ether, tetrabromocatechol diglycidyl ether; 3′,3″, 5′,5″-tetrabromophenolphthalein (CAS No. 1301-20-8) diglycidyl ether; 4,4′-biphenol diglycidyl ether; 1,3,5-trihydroxybenzene triglycidyl ether; 1,1,1-tris(4-hydroxyphenyl)ethane triglycidyl ether, and the like.

Multifunctional (meth)acrylates represented by the structure I are also available commercially. For example, a suitable multifunctional (meth)acrylate derived from tetrabrominated bisphenol A diglycidyl ether is RDX 51027 available from Cytec Surface Specialties. Other commercially available multifunctional acrylates include EB600, EB3600, EB3605, EB3700, EB3701, EB3702, EB3703, and EB3720, all available from Cytec Surface Specialties, and CN104 and CN120 available from SARTOMER.

The curable compositions of the present invention, and cured compositions prepared from them, comprise at least one silicone-containing surfactant. Silicone-containing surfactants are illustrated by polyalkyleneoxide modified polydimethyl siloxanes. In certain instances, the curable compositions of the present invention exhibit exceptional mold release properties upon curing. The preparation of polyalkyleneoxide modified polydimethyl siloxanes is well known in the art. Polyalkyleneoxide modified polydimethyl siloxanes of the present invention can be prepared according to the procedure set forth in U.S. Pat. No. 3,299,112. Silicone-containing surfactants are described in more detail in Kirk Othmer's Encyclopedia of Chemical Technology, 4th Ed., Vol. 22, pp. 82-142, “Surfactants and Detersive Systems.” Further suitable nonionic detergent surfactants are generally disclosed in U.S. Pat. No. 3,929,678, Laughlin et al., issued Dec. 30, 1975, at column 13, line 14 through column 16, line 6.

In one embodiment, the curable composition comprises a silicone-containing surfactant, said surfactant comprising a polyalkyleneoxide modified polydimethylsiloxane having structure V 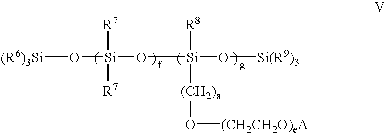
wherein R⁶, R⁷, R⁹, and R⁹ are independently at each occurrence a C₁-C₂₀ aliphatic radical; A is a hydrogen or a C₁-C₂₀ monovalent aliphatic radical; “a” and “e” are independently numbers ranging from 1 to 20; and “f” and “g” are independently numbers ranging from 1 to 50.

Silicone-containing surfactants are widely available commercially and typically comprise compositions comprising hydrophilic polyether substructures and hydrophobic silicon-containing substructures. SILWET 7602 and SILWET 720 are in some embodiments preferred silicone-containing surfactants and are available from OSi Specialty Chemicals, Ltd. Other suitable silicone-containing surfactants are illustrated by, but are not limited to SILWET L-7608, SILWET L-7607, SILWET L-77, SILWET L-7605, SILWET L-7604, SILWET L-7600, SILWET L-7657 and combinations thereof.

In one embodiment, the curable composition comprises a silicone-containing surfactant, wherein said surfactant comprises a polyalkyleneoxy group having a molecular weight is less than or equal to about 10,000 grams per mole (g/mol). In an alternate embodiment of the present invention, the molecular weight of the polyalkyleneoxy group is less than or equal to about 8,000 g/mol. In yet another embodiment the molecular weight of the polyalkyleneoxy group ranges from about 300 to about 5,000 g/mol.

Other silicone-containing surfactants are available from BYK-CHEMIE (for example, BYK-300 and BYK-301), DOW CORNING (for example, ADDITIVE 11 AND ADDITIVE 57), and EFKA (for example, EFKA 3236, EFKA 3239, EFKA 3299 and EFKA 3232).

The silicone-containing surfactant is typically present in an amount corresponding to from about 0.01 to about 5 weight percent based upon the total weight of the curable composition. In one embodiment, the silicone-containing surfactant is present in an amount corresponding to from about 0.1 to about 1 weight percent based upon the total weight of the curable composition. In an alternate embodiment of the present invention, the silicone-containing surfactant is present in an amount corresponding to from about 0.1 to about 0.5 weight percent based upon the total weight of the curable composition.

Typically, the multifunctional (meth)acrylate is present in the curable composition in an amount corresponding to from about 30 to about 80 weight percent of the total weight of the composition. In one embodiment, an amount of multifunctional (meth)acrylate greater than or equal to about 35 weight percent may be present in the curable composition. In yet another embodiment an amount of multifunctional (meth)acrylate greater than or equal to about 45 weight percent may be present in the curable composition. In still yet another embodiment, an amount of multifunctional (meth)acrylate greater than or equal to about 50 weight percent may be present in the curable composition. In one embodiment, an amount of multifunctional (meth)acrylate corresponding to less than or equal to about 75 weight percent may be may be present in the curable composition. In yet another embodiment, an amount of multifunctional (meth)acrylate corresponding to less than or equal to about 70 weight percent may be may be present in the curable composition. In still yet another embodiment, an amount of multifunctional (meth)acrylate corresponding to less than or equal to about 65 weight percent may be may be present in the curable composition.

Typically, monofunctional (meth)acrylate is present in the curable composition in an amount corresponding to from about 20 to about 50 weight percent of the total weight of the composition. Within this range, it may be preferred to use an amount of greater than or equal to about 20 weight percent, and in certain embodiments more preferably greater than or equal to about 30 weight percent.

In one embodiment, the present invention provides a curable composition wherein said multifunctional (meth)acrylate I is present in an amount corresponding to from about 30 to about 80 weight percent of the total weight of the composition, and said monofunctional (meth)acrylate is present in an amount corresponding to from about 20 to about 70 weight percent of the total weight of the composition.

As noted, in one embodiment, the present invention provides a curable composition comprising (a) at least one silicone containing surfactant, wherein the surfactant is present in a range corresponding to from about 0.01 to about 5 weight percent based upon the total weight of the composition; (b) a multifunctional (meth)acrylate represented by the structure I; (c) at least one nanoparticulate filler; and (d) at least one monofunctional (meth)acrylate. In one embodiment, the monofunctional (meth)acrylate is selected from the group consisting of methyl acrylate, methyl (meth)acrylate, and arylether (meth)acrylate monomers having structure VI 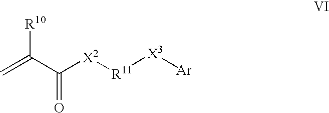
wherein R¹⁰ is hydrogen or methyl; X² and X³ are independently in each instance O, S, or Se; R¹¹ is a divalent C₁-C₂₀ aliphatic radical, a divalent C₃-C₂₀ cycloaliphatic radical, or a divalent C₃-C₂₀ aromatic radical; and Ar is monovalent C₃-C₂₀ aromatic radical.

In an alternate embodiment, the present invention provides a curable composition comprising (a) at least one silicone containing surfactant, wherein the surfactant is present in a range corresponding to from about 0.01 to about 5 weight percent based upon the total weight of the composition; (b) a multifunctional (meth)acrylate represented by the structure I; (c) at least one nanoparticulate filler; and (d) at least one monofunctional (meth)acrylate having structure VI.

Suitable monofunctional (meth)acrylates having structure VI are illustrated by, but are not limited to, the specific examples provided in Table 2 below.

TABLE 2
MONOFUNCTIONAL (METH)ACRYLATES HAVING STRUCTURE
VI

| Example | R¹⁰ | X² | R¹¹ | X³ | Ar |
|---|---|---|---|---|---|
| II-1 | Me | O | 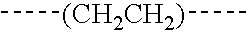 | O | 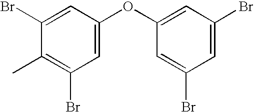 |
| II-2 | H | O | 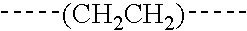 | S | 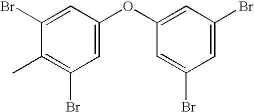 |
| II-3 | H | O | 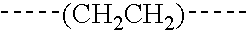 | S | 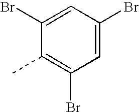 |
| II-4 | H | O | 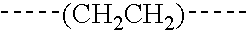 | Se | 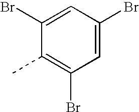 |
| II-5 | Me | O | 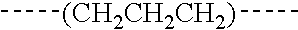 | Se | 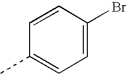 |
| II-6 | Me | S | 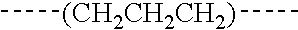 | Se | 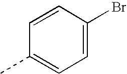 |
| II-7 | Me | S | 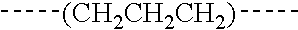 | S | 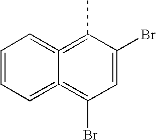 |
| II-8 | Me | O | 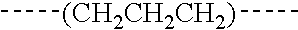 | S | 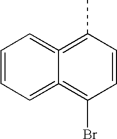 |
| II-9 | Me | O | 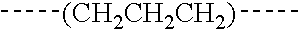 | S | 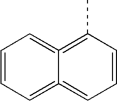 |
| II-10 | Me | O | 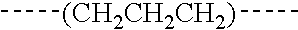 | S | 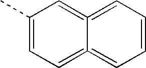 |

In one embodiment, the present invention provides a curable composition comprising at least one monofunctional (meth)acrylate which is a phenylthioethyl (meth)acrylate having structure VII 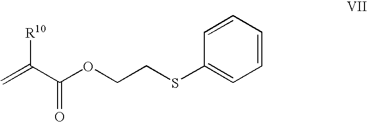
wherein R¹⁰ is hydrogen or methyl.

In an alternate embodiment, the present invention provides a curable composition comprising at least one monofunctional (meth)acrylate which is a naphthylthioethyl (meth)acrylate VIII 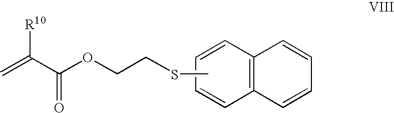
wherein R¹⁰ is hydrogen or methyl.

In addition to providing curable compositions, the present invention also provides cured compositions prepared from the curable compositions and articles comprising the cured compositions. Any of the curable compositions disclosed herein may be converted into the corresponding cured composition by polymerizing the multifunctional (meth)acrylate and monofunctional (meth)acrylate components of the curable composition. Those skilled in the art will appreciate that the multifunctional (meth)acrylate and monofunctional (meth)acrylate components of the curable composition will be consumed as the curable composition is cured to give the cured composition. Those skilled in the art will further appreciate that the multifunctional (meth)acrylate and monofunctional (meth)acrylate components of the curable composition will be converted into structural units derived from the multifunctional (meth)acrylate components and structural units derived from the monofunctional (meth)acrylate components. For example, a curable composition comprising as the monofunctional (meth)acrylate a phenylthioethyl (meth)acrylate having structure VII will, upon curing, comprise structural units derived from the phenylthioethyl (meth)acrylate VII, said structural units being represented by structure IX 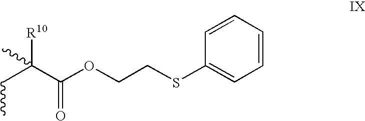
wherein R¹⁰ is hydrogen or methyl, and further wherein the wavy lines [symbol] indicate the connections to adjacent structural units within the cured composition. Those skilled in the art will appreciate that in most instances, the non-polymerizable components of the curable composition will be present in the cured composition as well.

Thus, in one embodiment, the present invention provides a cured composition comprising:

(a) at least one silicone containing surfactant, wherein the surfactant is present in a range corresponding to from about 0.01 to about 5 weight percent based upon the total weight of the composition;

(b) structural units derived from at least one multifunctional (meth)acrylate represented by the structure I 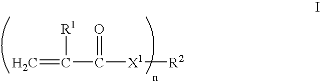
wherein R¹ is hydrogen or methyl; X¹ is O, S, or Se; n is at least 2; and R² is a polyvalent aromatic radical;

(c) at least one nanaoparticulate filler; and

(d) structural units derived from at least one monofunctional (meth)acrylate.

As noted, the curable compositions of the present invention comprise at least one nanoparticulate filler. Nanoparticulate fillers, which are also referred to as “nanoscale fillers” are particulate materials which are nanoscale in size having a particle size no greater than about 250 nanometers (nm). In one embodiment, the particle size is preferably between about 1 nanometers and about 100 nanometers, or any range there between. In yet another embodiment of the present invention the particle size is between about 5 nanometers and about 50 nanometers. Measurements of nanoparticulate filler particle size may be made using known techniques such as transmission electron microscopy (TEM).

Examples of materials suitable for use as nanoparticulate fillers include, but are not limited to nanoparticulate silica, zirconia, titania, ceria, alumina, antimony oxide, and mixtures thereof. Metal oxide nanoparticles are also referred to herein at times as “nanoparticulate metal oxides”. In one embodiment, the nanoparticulate filler comprises a nanoparticulate mixed metal oxide. Nanoparticulate fillers comprising a variety of metal oxides are commercially available. For example, nanoparticulate silica is available in a variety of forms from DeGussa AG. Mixed metal oxide nanoparticles are available from the Catalysts and Chemical Industries Corporation (Japan).

In one embodiment of the present invention, the nanoparticulate filler additionally comprises organic functional groups. Suitable organic functional groups include (meth)acryloyloxy groups 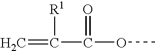
wherein R¹ is hydrogen or methyl. Other suitable organic functional groups include aliphatic radicals such as decyl groups, cycloalipghhatic radicals such as cyclohexylethyl groups, and aromatic radicals such as styryl groups. The structure of the functional groups present in the functionalized nanoparticulate filler may be adjusted depending upon the requirements of the application for which the composition is intended. For example, the structure of the functional groups present in the functionalized nanoparticulate filler may be tailored to provide a functionalized nanoparticulate filler having a hydrophobic surface as in the case of an functionalized nanoparticulate filler comprising surface decyl groups. Alternatively, the structure of the functional groups present in the functionalized nanoparticulate filler may be tailored to provide a nanoparticulate filler having a hydrophilic surface. As in the case of functionalized nanoparticulate fillers comprising (meth)acryloyloxy groups, the functional groups may be tailored to provide a functionalized nanoparticulate filler which is reactive with (meth)acryloyloxy groups present in other components of a curable composition. For example, in one embodiment, the present invention provides a curable composition comprising (a) at least one silicone containing surfactant, wherein the surfactant is present in a range corresponding to from about 0.01 to about 5 weight percent based upon the total weight of the composition; (b) at least one multifunctional (meth)acrylate represented by the structure I; and (c) at least one functionalized nanoparticulate filler, said functionalized nanoparticulate filler comprising (meth)acryloyloxy groups. In an alternate embodiment, the present invention provides a curable composition comprising (a) at least one silicone containing surfactant, wherein the surfactant is present in a range corresponding to from about 0.01 to about 5 weight percent based upon the total weight of the composition; (b) at least one multifunctional (meth)acrylate represented by the structure I; (c) at least one functionalized nanoparticulate filler, said functionalized nanoparticulate filler comprising (meth)acryloyloxy groups; and (d) at least one monofunctional (meth)acrylate. In one embodiment, the functionalized nanoparticulate filler comprises functional groups which are relatively inert (e.g. ureido groups). In one embodiment, the present invention provides a curable compositon comprising a nanoparticulate filler which is a nanoparticulate titania coated with a urea formadehyde resin. Functionalized nanoparticulate fillers comprising relatively inert functioanl groups are useful in applications requiring greater stability of the nanoparticulate filler component of the composition.

In one embodiment, the nanoparticulate filler is an acrylate functionalized inorganic nanoparticle, for example, an acrylate functionalized nanoparticulate silica, zirconia, titania, ceria, alumina, antimony oxide, or mixture thereof. In a particular embodiment, the nanoparticulate filler is an acrylate functionalized silica. In another embodiment, the nanoparticulate filler is an acrylate functionalized mixed metal oxide. The acrylate functionalized inorganic nanoparticulate filler can be produced by adding an acrylate functionalized alkoxy silane such as acryloyloxypropyl trimethoxysilane, methacryloyloxypropyl trimethoxysilane, acryloyloxypropyl triethoxysilane, methacryloyloxypropyl triethoxysilane, mixtures of two or more of the foregoing, and the like to an aqueous mixture of the inorganic nanoparticle, (for example an aqueous mixture comprising a nanoscale silica colloid) and heating the mixture to promote condensation of reactive groups on the surface of the inorganic nanoparticle (for example hydroxyl groups) with the acrylate functionalized alkoxy silane. Those skilled in the art will appreciate that a nanoparticle may be “completely functionalized” or “partially functionalized” and the degree to which a nanoparticle is functionalized may depend on the relative amounts of functionalizing agent and the parent nanoparticle employed in the functionalization reaction. In one embodiment, the degree to which a nanoparticle is functionalized may be predicted based upon a proposition (See ILER in U.S. Pat. No. 2,786,042) that each gram of nanoparticle will require 19.7/d millimoles (19.7 divided by the diameter of the nanoparticle expressed in nanometers) of functionalizing agent to achieve complete (100%) functionalization. While not wishing to be bound by this relationship, it may nonetheless serve as a guide to those wishing to effect complete or partial functionalization of a nanoparticle. In one embodiment, the nanoparticle is fully functionalized. In another embodiment, the nanoparticle is from about 1% to about 100% functionalized. In yet another embodiment another embodiment, the nanoparticle is from about 3% to about 75% functionalized. In yet still another embodiment, the nanoparticle is from about 5% to about 50% functionalized. In one embodiment, the inorganic nanoparticle comprises nanoparticulate silica, the nanoparticulate silica comprising silanol groups (SiOH) groups which are then condensed with an acryloyloxy silane (for example methacryloyloxypropyl trimethoxysilane). In one embodiment, water is removed from the mixture comprising the product functionalized nanoparticulate filler, by the addition of an organic solvent followed by vacuum stripping. Removal of water allows solution blending of the functionalized nanoparticulate filler with the other components of the curable composition. Suitable materials for the organic solvents include organic solvents forming azeotropes with water (for example t-butanol) and solvents having a boiling point higher than that of water. In one embodiment, the solvent is an acrylate, for example ethyl methacrylate (boiling point=118-119° C.).

The amount and/or nature of the nanoparticulate filler in the curable composition may be adjusted depending upon the requirements of the application for which the composition is intended. The term “nature of nanoparticulate filler” is meant to encompass the composition, chemical properties and physical properties of the nanoparticulate filler. For example, the desired useable shelf life of a curable composition may be adjusted by varying the amount and/or nature of the nanoparticulate filler. Other properties of the curable composition and cured compositions prepared from it may be adjusted by varying the amount and/or nature of the nanoparticulate filler present in the curable composition. Properties which may be tailored by varying the amount and/or nature of the nanoparticulate filler include adhesion, abrasion resistance, weatherability, and thermal crack resistance to name a few.

Typically, the amount of nanoparticulate filler present in the compositions of the present invention is less than about 65 weight percent of the total weight of the composition. In one embodiment, the nanoparticulate filler in the curable composition is present in an amount corresponding to from about 1 weight percent to about 65 weight percent based upon the total weight of the curable composition. In another embodiment, the nanoparticulate filler is present in an amount corresponding to from about 1 to about 40 weight %. In yet another embodiment, the nanoparticulate filler is present in an amount corresponding to from about 3 to about 35 weight %. In yet another embodiment, the nanoparticulate filler is present in an amount corresponding to from about 5 to about 30 weight %. In another embodiment, the nanoparticulate filler is present in an amount corresponding to from about 1 to about 15 weight %.

The curable compositions of the present invention may, optionally, further comprise an additive selected from flame retardants, antioxidants, thermal stabilizers, ultraviolet stabilizers, dyes, colorants, anti-static agents, and the like, and a combination comprising at least one of the foregoing additives, so long as the additive does not deleteriously affect the polymerization of the composition.

The curable compositions of the present invention provide materials having excellent refractive indices without the need for the addition of known high refractive index additives. Such compositions, when cured into microstructured films, provide films exhibiting excellent brightness.

The curable composition may be prepared by simply blending the components thereof, with efficient mixing to produce a homogeneous mixture. When forming articles from the curable composition, it is often preferred to remove air bubbles by application of vacuum or the like, with gentle heating if the mixture is viscous. The composition can then be charged to a mold that may bear a microstructure to be replicated and polymerized by exposure to ultraviolet radiation or heat to produce an article comprising the cured composition.

In one embodiment, the curable composition is applied as a liquid to a surface of a base film substrate. The coated base film is then passed through a compression nip defined by a nip roll and a casting drum, the casting drum having a negative pattern master of the microstructures desired in the cured film. The compression nip applies a sufficient pressure to the uncured composition and the base film substrate to control the thickness of the coating of the curable composition and to press the composition into full dual contact with both the base film substrate and the casting drum to exclude any air between the composition and the drum. The base film substrate can be made of any material that can provide a sufficient backing for the curable composition such as, for example, polymethyl methacrylate (i.e., PLEXIGLASS™), polyester (e.g. MYLART™), polycarbonate (such as LEXAN™), polyvinyl chloride (VELBEX®), or even paper. In a preferred embodiment, the base film substrate is a bisphenol A polycarbonate film.

In one embodiment, the curable composition is cured by directing radiation energy through the base film substrate from the surface opposite the surface coated with the curable composition while the curable composition is in full contact with the casting drum to cause the microstructured pattern of the casting drum to be replicated in the cured composition layer. This process is particularly suited for continuous preparation of a cured composition disposed upon transparent substrate.

In one embodiment, the curable compositions are preferably cured by UV radiation. The wavelength of the UV radiation may be from about 1800 angstroms to about 4000 angstroms. Suitable wavelengths of UV radiation include, for example, UVA, UVB, UVC, UVV, and the like; the wavelengths of the foregoing are well known in the art. The lamp systems used to generate such radiation include ultraviolet lamps and discharge lamps, as for example, xenon, metallic halide, metallic arc, low or high pressure mercury vapor discharge lamp, and the like. The term “curing” includes both polymerization (chain growth steps) and, optionally, cross-linking steps to form a non-tacky material.

When heat curing is used, the temperature selected is typically in a range from about 80° to about 130° C. Within this range, a temperature of greater than or equal to about 90° C. may be preferred. Also within this range, a temperature of greater than or equal to about 100° C. may be preferred. The heating period is typically in a range of from about 30 seconds to about 24 hours. In certain embodiments, it may be preferred to use a heating time of greater than or equal to about 1 minute, more preferably greater than or equal to about 2 minutes. Such curing may be staged to produce a partially cured and often tack-free composition, which then is fully cured by heating for longer periods. In one embodiment, the composition may be both heat cured and UV cured.

In one embodiment, the curable composition is may be used in a continuous process to prepare a cured film material in combination with a substrate. To achieve the rapid production of cured material using a continuous process, the composition preferably cures in a short amount of time.

Current manufacturing processes for the low cost production of cured films, particularly light management films, require rapid and efficient curing of materials followed by easy release of the cured film from the mold. The curable compositions of the present invention have been found to efficiently cure under typical conditions employed for the rapid, continuous production of cured, coated films employing UV irradiation. Such compositions exhibit excellent relative degree of cure under a variety of processing conditions.

In one embodiment, the present invention provides a curable composition comprising at least one silicone containing surfactant, wherein the surfactant is present in a range corresponding to from about 0.01 to about 5 weight percent based upon the total weight of the composition; about 80 to about 20 weight percent of a multifunctional (meth)acrylate; about 20 to about 80 weight percent of a monofunctional (meth)acrylate, 0.01 to about 1 weight percent of an aliphatic a C₁₀-C₄₀ aliphatic acid; and about 0.1 to about 2 weight percent of a phosphine oxide photoinitiator.

Other embodiments of the present invention include articles made from any of the curable compositions. Articles that may be fabricated from the compositions of the present invention include, for example, optical articles, such as light management films for use in back-light displays, projection displays, traffic signals, illuminated signs, optical lenses; Fresnel lenses, optical disks, diffuser films, holographic substrates, and as substrates in combination with conventional lenses, prisms or mirrors.

### EXAMPLES

The following examples are intended only to illustrate methods and embodiments in accordance with the invention, and as such should not be construed as imposing limitations upon the claims. Unless specified otherwise, all ingredients are commercially available.

The compositions prepared in Examples 1-7 and Comparative Examples 2-10 did not contain a nanoparticulate filler. Data for Examples 1-7 and Comparative Examples 2-10 are reproduced here to illustrate the surprising effect of silicone containing surfactants on the performance of films prepared from the curable compositions of the invention. The formulations for Examples 1-7 and Comparative Examples 2-10 were prepared from the components listed in Table 3.

TABLE 3

| Component | Trade Name | Description | Source |
|---|---|---|---|
| RDX51027 (“RDX”) | RDX51027 | Diacrylate of tetrabromo | Cytec Surface |
| | | bisphenol-A diglycidyl | Specialties |
| | | ether | |
| PTEA | BX-PTEA | Phenylthioethyl acrylate | Bimax |
| | | | Company |
| PEA | SR339 | 2-Phenoxyethyl acrylate | Sartomer |
| IRGACURE | IRGACURE | Bis(2,4,6-trimethylbenzoyl)- | Ciba-Geigy |
| | 819 | phenylphosphine oxide | |
| Darocur | Darocur | 2-Hydroxy-2-methyl-1-phenyl-propan- | Ciba Specialty |
| | 4265 | 1-one and Bis(2,4,6-trimethylbenzoyl)- | Chemicals |
| | | phenylphosphine oxide | |
| HDDA | SR238 | Hexanediol Diacrylate | Sartomer |
| BDDA | SR213 | Butanediol Diacrylate | Sartomer |
| Polyether modified | BYK301 | Polyether modified | BYK-Chemie |
| dimethylpolysiloxane-copolymer | | dimethylpolysiloxane-copolymer | |
| Polyether modified | SILWET | Polyether modified | OSi Specialty |
| dimethylpolysiloxane-copolymer | L7602 | dimethylpolysiloxane-copolymer | Chemicals, Ltd |
| Polyether modified | SILWET | Polyether modified | OSi Specialty |
| dimethylpolysiloxane-copolymer | L720 | dimethylpolysiloxane-copolymer | Chemicals, Ltd |
| Polycarbonate | Lexan | Optical Quality Film | GE Advanced |
| | | | Materials |

A laminating process was used to coat polycarbonate film. The laminating unit consisted of two rubber rolls: a bottom variable speed drive roll and a pneumatically driven top nip roll. This system was used to press together laminate stacks that are passed between the rolls. Coated films were prepared by placing approximately 5 mL of liquid coating at the front or leading edge of an 11″×12″ electroformed tool held in place on a steel plate by adhesive tape. A piece of polycarbonate film was then placed over the electroformed tool with the liquid coating and the resulting stack sent through the laminating unit to press and distribute the photopolymerizable liquid uniformly between the electroformed tool and polycarbonate substrate. Photopolymerization of the coating within the stack was accomplished using a Fusion EPIC 6000UV curing system by passing the stack under a 600-watt V-bulb.

After curing, the coated polycarbonate film was removed from the electroformed tool by peeling away. This was accomplished by lifting the film away from the electroformed tool at approximately a 45-90 degree angle. When no surfactant was used, considerable force was required to peel the coated film from the electroformed tool, i.e. molding tool, whereas less force was required when the proper release additive was used. The effort or force required to remove the coated film from the tool was assessed and used to develop a Mold Release Score as described in Table 4. Typically, the problems with the nature of the release include buckling or curling of the film after release, phase separation of components, delamination of the coated film from the plastic backing, adhesion to the plastic backing. The coated cured flat film was then peeled from the flat tool and used for abrasion, % haze, % transmission, color, yellowness index, and adhesion measurements.

Coated cured microstructured films for measuring luminance were made in the same manner as coated cured flat films by substituting the highly polished flat steel plate with an electroformed tool with a prismatic geometry. The geometry of the prisms can be found in FIG. 6 of the copending U.S. application Ser. No. 10/065,981 entitled “Brightness Enhancement Film With Improved View Angle” filed Dec. 6, 2002, which is incorporated by reference herein in its entirety.

TABLE 4

| | | Tool | Cure | Strip | Tool | □ |
|---|---|---|---|---|---|---|
| Example | | Temp | Temp | Temp | Release | Lumi- |
| No. | Formulation | (° F.) | (° F.) | (° F.) | Score * | nance |
| Example 1 | 59.5% RDX/ | 104 | 111 | 102 | ++++ | − |
| | 39.5% PTEA/1% | | | | | |
| | SILWET L720 | | | | | |
| Example 2 | 59.75% RDX/ | 103 | 104 | 104 | +++ | (−)1% |
| | 39.75% | | | | | |
| | PTEA/0.5% | | | | | |
| | SILWET L7602 | | | | | |
| Example 3 | 59.9% RDX/ | 106 | 109 | 106 | +++ | (−)1% |
| | 39.9% | | | | | |
| | PTEA/0.2% | | | | | |
| | SILWET L720 | | | | | |
| Comparative | 60% RDX/ | 106 | 109 | 102 | ++ | (−)2% |
| Example 2 | 35% PTEA/ | | | | | |
| | 5% HDDA | | | | | |
| Comparative | 60% RDX/ | 106 | 109 | 104 | + | (−)2% |
| Example 3 | 35% PTEA/5% | | | | | |
| | 1,4-BDDA | | | | | |
| Comprative | 60% RDX/ | 106 | 109 | 102 | + | |
| Example 4 | 37.5% PTEA/ | | | | | |
| | 2.5% HDDA | | | | | |
| Comparative | 60% RDX/ | 106 | 108 | 102 | + | |
| Example 5 | 35% PTEA/ | | | | | |
| | 2.5% 1,4-BDDA | | | | | |
| Example 4 | 59.95% RDX/ | 105 | 105 | 104 | + | |
| | 39.95% | | | | | |
| | PTEA/0.1% | | | | | |
| | SILWET L7602 | | | | | |
| Example 5 | 59.9% RDX/ | 95 | 108 | 95 | + | |
| | 39.9% | | | | | |
| | PTEA/0.2% | | | | | |
| | SILWET L720 | | | | | |
| Example 6 | 59.95% RDX/ | 105 | 104 | 104 | + | |
| | 39.95% | | | | | |
| | PTEA/0.1% | | | | | |
| | SILWET L720 | | | | | |
| Example 7 | 60% RDX/ | 104 | 105 | 102 | − | |
| | 40% PTEA/0.3% | | | | | |
| | BYK301 | | | | | |
| Comparative | 60% RDX/ | 106 | 105 | 99 | − | |
| Example 7 | 40% PTEA | | | | | |
| Comparative | 60% RDX/ | 95 | 95 | 93 | − | |
| Example 8 | 30% PTEA/ | | | | | |
| | 10% HDDA | | | | | |
| Comparative | 60% RDX/ | 81 | 88 | 86 | −− | |
| Example 9 | 40% PTEA | | | | | |
| Comparative | 60% RDX/ | 73 | 82 | 80 | −−− | |
| Example 10 | 40% PTEA | | | | | |

* The tool release score is a measure of the release of the film from the tool and is a combination of multiple characteristics such as release, buckling of the film, adhesion to the substrate, and luminance.
“++++” represents excellent release and excellent film characteristics,
“+++” represents excellent release and good film characteristics,
“++” represents good release and good film characteristics,
“+” represents average release and average film characteristics,
“−“ represents a weakness in either the release or the film characteristics,
“−−“ represents poor release and poor film characteristics,
“−−−“ represents very poor release and very poor film characteristics

The data in Table 4 demonstrate that those compositions comprising the silicone-containing surfactants, even in concentrations as low as 0.1% by weight to 1% by weight, possess better release characteristics as compared to the compositions that do not contain the surfactants. There was reduced delamination between the coating and polymer substrate, better adhesion between the two layers, and excellent release for those compositions comprising the silicone-containing surfactant. These examples show the surprising discovery of the effect of silicone-containing surfactants at low concentrations on the coating compositions. While the data in Table 4 also show that HDDA was effective for providing acceptable tool release characteristics, its use was accompanied by an unacceptably high loss of luminance.

Curable Compositions Comprising Nanoparticulate Fillers: Examples 8-13 Preparation of Curable Compositions Comprising Antimony Oxide Nanoparticles.

Examples 9-13 were prepared according to the following procedure using varying amounts of the antimony oxide nanoparticle. Example 8 was prepared identically but without the incorporation of the antimony oxide nanoparticle. Suncolloid AMT-330S antimony oxide (particle size less than 7 nm) as a mixture comprising 30% solids in methanol, was obtained from Nissan Chemical Industries, Ltd. To 100 parts by weight (pbw) of a curable composition comprising 60 pbw RDX 51027 tertrabromo BPA “epoxy” acrylate (Cytec Surface Specialties), 40 pbw phenylthioethyl acrylate, 0.50 pbw IRGACURE 819, 0.25 pbw acrylic acid, and 0.25 pbw SILWET 7602 was added an amount of the Suncolloid AMT-330S corresponding to the amount set forth in Table 5 below. Methanol was removed by distillation to afford the curable composition containing various levels of dispersed antimony oxide.

TABLE 5
Curable Compositions Comprising Varying Levels
of Unfunctionalized Sb₂O₃ Nanoparticles

| | Curable | Suncolloid | Sb₂O₅ in UV |
|---|---|---|---|
| Example No. | Composition pbw | AMT-330S, pbw | Resin, % |
| 8 | 100 | 0 | 0 |
| 9 | 100 | 17.5 | 5 |
| 10 | 100 | 29 | 8 |
| 11 | 100 | 37 | 10 |
| 12 | 100 | 45.5 | 12 |
| 13 | 100 | 58.8 | 15 |

Preparation of Cured Films Comprising Surface Microstructures

The curable compositions of Examples 8-13 were used to prepare cured films comprising surface microstructures. The cured film samples were prepared on a continuous polycarbonate base film. Thus, about 5 grams of each of the curable compositions of Examples 8-13 was applied as a bead across the web between a nip roll and a cast roll held at 50° C. The cast roll had attached to its outer surface a metal form with a microstructured surface. The coating formulation was cured while in contact with the microstructured surface of the metal form by exposure to the output of two high intensity UV lamps equipped with V-bulbs with the web running at 50 feet per minute. This technique was employed for each of the curable compositions of Examples 8-13 to provide cured films comprising surface microstructures, said films comprising structural units derived from RDX51027 diacrylate and phenylthioethyl acrylate, as well as the silicone surfactant, presumably unchanged by the irradiative curing step. The cured films prepared from the curable compositions of Examples 9-13 also comprised the antimony oxide nanoparticles in the amounts shown in Table 5. The cured films prepared from the curable composition of Example 8 contained no antimony oxide nanoparticles. All of the cured films exhibited excellent mold release.

Cured Film Abrasion Tests

The abrasion performance of the cured film samples was measured in an oscillating bead abrasion test. Prior to being subjected to the oscillating bead abrasion test, the percent transmission of each of the cured film prepared from the curable compositions of Examples 8-13 was measured using a Gardner HAZE-GARD PLUS instrument by shining the collimated light through the back side of the microstructured film. The total internal reflection properties of such films results in very low transmission in this configuration. Any increase in % transmission after abrasion is a direct measure of damage to the prismatic structures. In the abrasion test the cured test film was attached to the bottom of a flat bin and 13.5 grams of 4 mm glass beads were placed on top of the film. The bin was placed on an oscillator and oscillated at 180 oscillations per minute (opm) for 2 minutes. The test film was then removed and the percent transmission of the film was measured. Four replicate cured films made from each of the curable compositions of Examples 8-13 were subjected to this test. The difference in percent transmission before and after glass bead abrasion was averaged. A BEFII film (3M Corporation) was subjected to the abrasion resistance test. Abrasion test results for the BEFII are included here as a control. Results are set forth in the Table 6 below.

TABLE 6
Abrasion Performance Of Films Prepared From
The Curable Compositions Of Examples 8-13

| | Sb₂O₅ in Curable | % Change in |
|---|---|---|
| Example No. | Composition | Transmittance |
| 8 | 0% | 1.06 |
| 9 | 5% | 1.2 |
| 10 | 8% | 1.28 |
| 11 | 10% | 1.15 |
| 12 | 12% | 1.11 |
| 13 | 15% | 1.13 |
| BEFII Control | 0% | 0.73 |

The data in Table 6 show that the inclusion of unfunctionalized antimony oxide nanoparticles in the curable composition did not improve abrasion resistance (as measured by the glass bead abrasion test) of cured films prepared from the curable compositions of the present invention. A smaller change in % transmission was taken to indicate better abrasion resistance.

### Example 14

### Preparation of Chemically Modified Antimony Oxide Nanoparticles in UV Resin

To 120.7 pbw of the Suncolloid AMT-330S antimony oxide nanoparticle dispersion was added 12.93 pbw of 3-methacryloxypropyltrimethoxysilane, and 4.73-pbw water. The mixture was then heated to reflux. After refluxing for 2 hours, the dispersion was cooled and 25 pbw of t-butanol (solvent) was added. To this mixture was then added 112 grams of a curable composition comprising 60 pbw RDX51027 brominated epoxy acrylate (Cytec Surface Specialties), 40-pbw phenylthioethyl acrylate, 0.50 pbw IRGACURE 819, 0.25 pbw acrylic acid, and 0.25 pbw SILWET 7602 silicone polyether copolymer. Solvent was then removed under reduced pressure to afford curable composition comprising chemically modified antimony oxide nanoparticles.

Preparation of Cured Films Comprising Chemically Modified Antimony Oxide Nanoparticles

Cured films incorporating surface microstructures were prepared as described for the cured films prepared from the curable compositions of Examples 8-13. The curable composition of Example 14 comprising the chemically modified antimony oxide nanoparticles was used to prepare a representative number of cured films for abrasion and luminance testing.

Oscillating Bead Abrasion Resistance Cured Films Comprising Chemically Modified Antimony Oxide Nanoparticles

The abrasion resistance of cured films prepared from the curable composition of Example 14 was carried out as described for cured films prepared from the curable compositions of Example 8-13. A BEFII film was included as a control. Results are gathered in Table 7.

TABLE 7

| | Sb₂O₅ in Curable | Change in % |
|---|---|---|
| Example | Comporion % | Transmission |
| Example 14 | 25 | 0.43* |
| BEF II (control) | 0 | 0.57 |

*Average value based on four test films.

The data in Table 7 demonstrate that the cured films prepared from the curable composition of Example 14 exhibits better abrasion resistance than a control film, BEFII. It is believed that the presence of reaction products in the cured film of the chemically modified antimony oxide nanoparticles with other reactive components in the curable composition (e.g. the multifunctional (meth)acrylate) provides a cured film with a more robust microreplicated surface relative to the control film.

Luminance of Cured Films Prepared from Curable Compositions Comprising Chemically Modified Antimony Oxide Nanoparticles

Cured films supported on a polycarbonate substrate film were prepared using the curable composition of Example 14 and the luminance of each film was measured and compared to luminance of an otherwise identical cured film prepared using the curable composition of Example 8 (no antimony oxide particles) and to a BEFII control film. The data obtained are presented in Table 8 and are “normalized” to the BEFII control result.

TABLE 8

| Example | Luminance |
|---|---|
| Cured film prepared from the curable compositon of | 107.1 |
| Example 8 (no Sb₂O₅) | |
| Cured film prepared from the curable compositon of | 107.8 |
| Example 14 (contains chemically modified Sb₂O₃) | |
| BEFII (control) | 100 |

The data in Table 8 demonstrate that cured films prepared from curable compositions comprising chemically modified antimony oxide nanoparticles exhibit greater luminance than cured films prepared from curable compositions lacking chemically modified nanoparticles.

The foregoing examples are merely illustrative, and represent specific embodiments of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. A curable composition comprising:
(a) at least one silicone containing surfactant, wherein the surfactant is present in a range corresponding to from about 0.01 to about 5 weight percent based upon the total weight of the composition;
(b) at least one multifunctional (meth)acrylate represented by the structure I 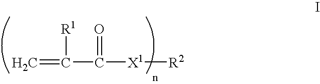
wherein R¹ is hydrogen or methyl; X¹ is O, S, or Se; n is at least 2; and R² is a polyvalent aromatic radical; and
(c) at least one nanoparticulate filler.

2. A curable composition comprising:
(a) at least one silicone containing surfactant, wherein the surfactant is present in a range corresponding to from about 0.01 to about 5 weight percent based upon the total weight of the composition;
(b) a multifunctional (meth)acrylate represented by the structure I 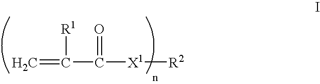
wherein R¹ is hydrogen or methyl; X¹ is O, S, or Se; n is at least 2; and R² is a polyvalent aromatic radical; and
(c) at least one nanoparticulate filler; and
(d) at least one monofunctional (meth)acrylate.

3. The curable composition according to claim 2, wherein said nanoparticulate filler comprises at least one nanoparticulate metal oxide selected from the group consisting of silica, zirconia, titania, ceria, alumina, antimony oxide, and mixtures thereof.

4. The curable composition according to claim 2, wherein said nanoparticulate filler comprises antimony oxide.

5. The curable composition according to claim 2, wherein said nanoparticulate filler comprises at least one organic functional group.

6. The curable composition according to claim 5, wherein said at least one organic functional group is selected from the group consisting of aliphatic radicals, cycloaliphatic radicals, and aromatic radicals.

7. The curable composition according to claim 5, wherein said at least one organic functional group comprises at least one (meth)acryloyloxy group.

8. The curable composition according to claim 2, wherein R² is a divalent aromatic radical having structure III 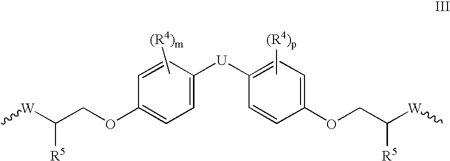
wherein and U is a bond, an oxygen atom, a sulfur atom, a selenium atom, an SO₂ group, an SO group, a CO group, a C₁-C₂₀ aliphatic radical, C₃-C₂₀ cycloaliphatic radical, or a C₃-C₂₀ aromatic radical; R⁴ is independently at each occurrence a halogen atom, a nitro group, a cyano group, an amino group, a hydroxy group, a C₁-C₂₀ aliphatic radical, a C₃-C₂₀ cycloaliphatic radical, or a C₃-C₂₀ aromatic radical; R⁵ is independently at each occurrence a hydrogen atom, a hydroxy group, a thiol group, or an amino group; W is a bond, a divalent C₁-C₂₀ aliphatic radical, a divalent C₃-C₂₀ cycloaliphatic radical, a divalent C₃-C₂₀ aromatic radical; and “m” and “p” are independently integers ranging from 0 to 4.

9. The curable composition according to claim 2, wherein the multifunctional (meth)acrylate comprises at least one di(meth)acrylate having structure IV 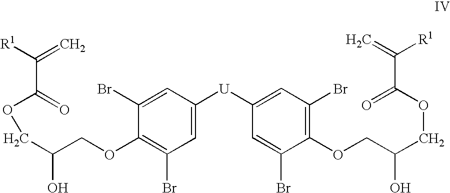
wherein R¹ is hydrogen or methyl, and U is a bond, an oxygen atom, a sulfur atom, a selenium atom, an SO₂ group, an SO group, a CO group, a C₁-C₂₀ aliphatic radical, C₃-C₂₀ cycloaliphatic radical, or a C₃-C₂₀ aromatic radical.

10. The curable composition according to claim 2, wherein said silicone-containing surfactant comprises a polyalkyleneoxide modified polydimethylsiloxane having structure V 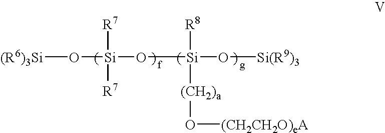
wherein R⁶, R⁷, R⁸ and R⁹ are independently at each occurrence a C₁-C₂₀ aliphatic radical; A is a hydrogen or a C₁-C₂₀ monovalent aliphatic radical; “a” and “e” are independently numbers ranging from 1 to 20; and “f” and “g” are independently numbers ranging from 1 to 50.

11. The curable composition according to claim 2, wherein said at least one silicone-containing surfactant is present in an amount corresponding to from about 0.1 to about 1 weight percent based upon the total weight of the composition.

12. The curable composition according to claim 2, wherein said multifunctional (meth)acrylate I is present in an amount corresponding to from about 30 to about 80 weight percent of the total weight of the composition, and said monofunctional (meth)acrylate is present in an amount corresponding to from about 20 to about 70 weight percent of the total weight of the composition.

13. The curable composition according to claim 2, wherein said at least one monofunctional (meth)acrylate is selected from the group consisting of methyl acrylate, methyl (meth)acrylate, and arylether (meth)acrylate monomers having structure VI 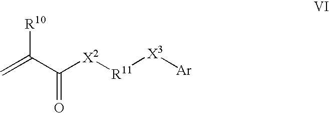
wherein R¹⁰ is hydrogen or methyl; X² and X³ are independently in each instance O, S, or Se; R¹¹ is a divalent C₁-C₂₀ aliphatic radical, a divalent C₃-C₂₀ cycloaliphatic radical, or a divalent C₃-C₂₀ aromatic radical; and Ar is monovalent C₃-C₂₀ aromatic radical.

14. The curable composition according to claim 2, wherein said at least one monofunctional (meth)acrylate comprises phenylthioethyl (meth)acrylate VII 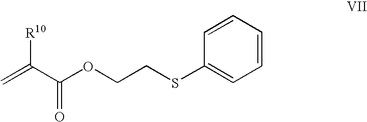
wherein R¹⁰ is hydrogen or methyl.

15. The curable composition according to claim 2, wherein said at least one monofunctional (meth)acrylate comprises naphthylthioethyl (meth)acrylate VIII 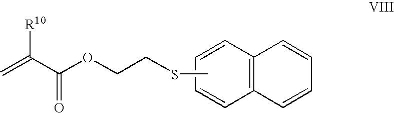
wherein R¹⁰ is hydrogen or methyl.

16. The curable composition according to claim 2, further comprising at least one polymerization initiator.

17. A curable composition comprising:
(a) at least one silicone-containing surfactant, said at least one silicone-containing surfactant being present in an amount corresponding to from about 0.1 to about 1 weight percent based upon the total weight of the composition;
(b) a multifunctional (meth)acrylate represented by the structure I 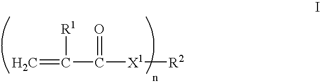
wherein R¹ is hydrogen or methyl; X¹ is O, S, or Se; n is 2; and R² is a divalent aromatic radical;
(c) at least one nanoparticulate filler; and
(d) at least one monofunctional (meth)acrylate having structure VI 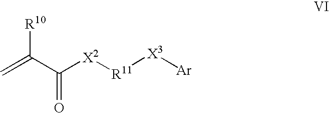
wherein R¹⁰ is hydrogen or methyl; X² and X³ are independently in each instance O, S, or Se; R¹¹ is a divalent C₁-C₂₀ aliphatic radical, a divalent C₃-C₂₀ cycloaliphatic radical, or a divalent C₃-C₂₀ aromatic radical; and Ar is monovalent C₃-C₂₀ aromatic radical.

18. The curable composition according to claim 17, further comprising an aliphatic acid having structure II 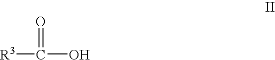
wherein wherein R³ is a C₉-C₃₉ aliphatic radical, said aliphatic acid being present in an amount corresponding to from about 0.01 to about 1 weight percent based upon a total weight of the composition.

19. The curable composition according to claim 18, wherein said aliphatic acid comprises at least one fatty acid selected from the group consisting of myristic acid, palmitic acid, stearic acid, oleic acid, linoleic acid, linolenic acid, and eicosanoic acid.

20. The curable composition according to claim 17, wherein said multifunctional (meth)acrylate comprises a di(meth)acrylate having structure IV 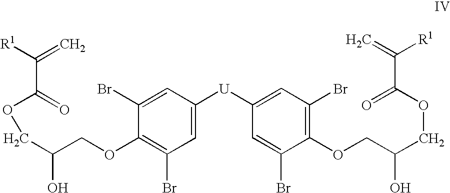
wherein R¹ is hydrogen or methyl, and U is a bond, an oxygen atom, a sulfur atom, a selenium atom, an SO₂ group, an SO group, a CO group, a C₁-C₂₀ aliphatic radical, C₃-C₂₀ cycloaliphatic radical, or a C₃-C₂₀ aromatic radical.

21. A curable composition comprising:
(a) at least one silicone-containing surfactant, said at least one silicone-containing surfactant being present in an amount corresponding to from about 0.1 to about 1 weight percent based upon the total weight of the composition;
(b) a multifunctional (meth)acrylate represented by the structure IV 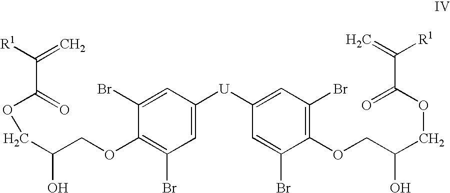
wherein R¹ is hydrogen or methyl, and U is a bond, an oxygen atom, a sulfur atom, a selenium atom, an SO₂ group, an SO group, a CO group, a C₁-C₂₀ aliphatic radical, C₃-C₂₀ cycloaliphatic radical, or a C₃-C₂₀ aromatic radical;
(c) at least one nanoparticulate filler comprising antimony oxide and at least one meth(acryloyloxy) group; and
(d) at least one monofunctional (meth)acrylate having structure VI 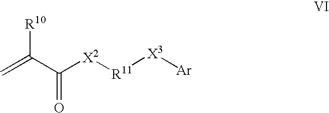
wherein R¹⁰ is hydrogen or methyl; X² and X³ are independently in each instance O, S, or Se; R¹¹ is a divalent C₁-C₂₀ aliphatic radical, a divalent C₃-C₂₀ cycloaliphatic radical, or a divalent C₃-C₂₀ aromatic radical; and Ar is monovalent C₃-C₂₀ aromatic radical.

22. A cured composition comprising:
(a) at least one silicone-containing surfactant, said at least one silicone-containing surfactant being present in an amount corresponding to from about 0.1 to about 5 weight percent based upon the total weight of the composition;
(b) structural units derived from at least one multifunctional (meth)acrylate represented by the structure I 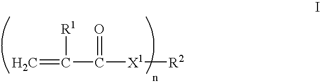
wherein R¹ is hydrogen or methyl; X¹ is O, S, or Se; n is at least 2; and R² is a polyvalent aromatic radical; and
(c) at least one nanoparticulate filler; and
(d) structural units derived from at least one monofunctional (meth)acrylate.

23. The cured composition according to claim 22, wherein R² is a divalent aromatic radical having structure III 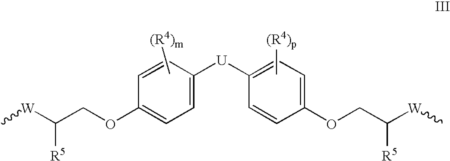
wherein and U is a bond, an oxygen atom, a sulfur atom, a selenium atom, an SO₂ group, an SO group, a CO group, a C₁-C₂₀ aliphatic radical, C₃-C₂₀ cycloaliphatic radical, or a C₃-C₂₀ aromatic radical; R⁴ is independently at each occurrence a halogen atom, a nitro group, a cyano group, an amino group, a hydroxy group, a C₁-C₂₀ aliphatic radical, a C₃-C₂₀ cycloaliphatic radical, or a C₃-C₂₀ aromatic radical; R⁵ is independently at each occurrence a hydrogen atom, a hydroxy group, a thiol group, or an amino group; W is a bond, a divalent C₁-C₂₀ aliphatic radical, a divalent C₃-C₂₀ cycloaliphatic radical, a divalent C₃-C₂₀ aromatic radical; and “m” and “p” are independently integers ranging from 0 to 4.

24. The cured composition according to claim 22, wherein the multifunctional (meth)acrylate comprises at least one di(meth)acrylate having structure IV 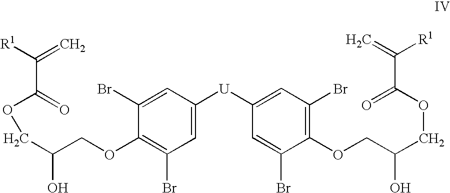
wherein R¹ is hydrogen or methyl, and U is a bond, an oxygen atom, a sulfur atom, a selenium atom, an SO₂ group, an SO group, a CO group, a C₁-C₂₀ aliphatic radical, C₃-C₂₀ cycloaliphatic radical, or a C₃-C₂₀ aromatic radical.

25. The cured composition according to claim 22, wherein said silicone-containing surfactant comprises a polyalkyleneoxide modified polydimethylsiloxane having structure V 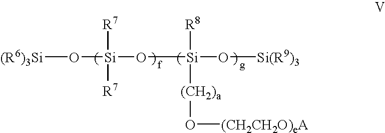
wherein R⁶, R⁷, R⁸, and R⁹ are independently in each instance a C₁-C₂₀ aliphatic radical; A is a hydrogen or a C₁-C₂₀ monovalent aliphatic radical; “a” and “e” are independently numbers ranging from 1 to 20; and “f” and “g” are independently numbers ranging from 1 to 50.

26. The cured composition according to claim 22, wherein said at least one silicone-containing surfactant is present in an amount corresponding to from about 0.1 to about 1 weight percent based upon the total weight of the composition.

27. The cured composition according to claim 22, wherein said strucrural units derived from the at least one multifunctional (meth)acrylate I are present in an amount corresponding to from about 50 to about 80 weight percent of the total weight of the cured composition, and said structural units derived from at least one monofunctional (meth)acrylate are present in an amount corresponding to from about 20 to about 50 weight percent of the total weight of the cured composition.

28. The cured composition according to claim 22, wherein said at least one monofunctional (meth)acrylate is selected from the group consisting of methyl acrylate, methyl (meth)acrylate, and arylether (meth)acrylate monomers having structure VI 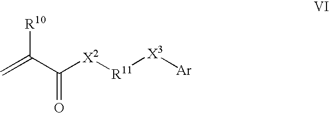
wherein R¹⁰ is hydrogen or methyl; X² and X³ are independently in each instance O, S, or Se; R¹¹ is a divalent C₁-C₂₀ aliphatic radical, a divalent C₃-C₂₀ cycloaliphatic radical, or a divalent C₃-C₂₀ aromatic radical; and Ar is monovalent C₃-C₂₀ aromatic radical.

29. The cured composition according to claim 22, wherein said at least one monofunctional (meth)acrylate comprises phenylthioethyl (meth)acrylate VII 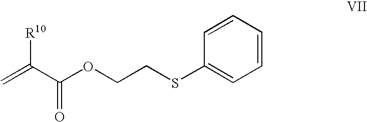
wherein R¹⁰ is hydrogen or methyl.

30. The cured composition according to claim 22, wherein said at least one monofunctional (meth)acrylate comprises naphthylthioethyl (meth)acrylate VIII 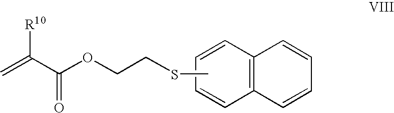
wherein R¹⁰ is hydrogen or methyl.

31. An article comprising a cured composition, said cured composiiton comprising:
(a) at least one silicone containing surfactant, wherein the surfactant is present in a range corresponding to from about 0.01 to about 5 weight percent based upon the total weight of the composition;
(b) structural units derived from at least one multifunctional (meth)acrylate represented by the structure I 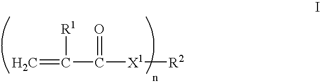
wherein R¹ is hydrogen or methyl; X¹ is O, S, or Se; n is at least 2; and R² is a polyvalent aromatic radical; and
(c) at least one nanoparticulate filler; and
(d) structural units derived from at least one monofunctional (meth)acrylate.

32. The article according to claim 31, said article comprising at least one surface microstructure.

33. The article according to claim 32 which is a brightness enhancement film.

34. An article comprising a cured composition, said cured composiiton comprising:
(a) at least one silicone containing surfactant, wherein the surfactant is present in a range corresponding to from about 0.01 to about 1 weight percent based upon the total weight of the composition;
(b) structural units derived from at least one multifunctional (meth)acrylate represented by the structure I 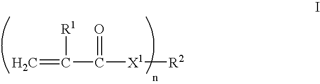
wherein R¹ is hydrogen or methyl; X¹ is O, S or Se; n is at least 2; and R² is a polyvalent aromatic radical;
(c) at least one nanoparticulate filler; and
(d) structural units derived from at least one monofunctional (meth)acrylate having structure VI 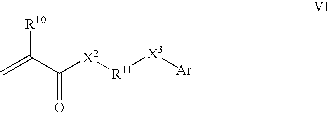
(e) wherein R¹⁰ is hydrogen or methyl; X² and X³ are independently in each instance O, S, or Se; R¹¹ is a divalent C₁-C₂₀ aliphatic radical, a divalent C₃C₂₀ cycloaliphatic radical, or a divalent C₃-C₂₀ aromatic radical; and Ar is monovalent C₃-C₂₀ aromatic radical.

35. The article according to claim 34, said article being a multilayer article comprising a substrate selected from the group consisting of glass, and thermoplastic materials.

36. The article according to claim 34, wherein said article comprises at least one surface microstructure.

37. A cured composition comprising:
(a) at least one silicone containing surfactant, wherein the surfactant is present in a range corresponding to from about 0.01 to about 5 weight percent based upon the total weight of the composition;
(b) structural units derived from at least one multifunctional (meth)acrylate represented by the structure I 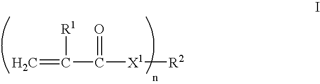
wherein R¹ is hydrogen or methyl; X¹ is O, S, or Se; n is at least 2; and R² is a polyvalent aromatic radical; and
(c) at least one nanoparticulate filler.
